(19) United States
(12) Patent Application Publication
(10) Pub. No.: US 2026/0267691 A1
(43) Pub. Date: Sep. 10, 2026

(54) SYSTEM AND METHOD FOR AN ADAPTABLE SCHEDULER

(71) Applicant: JIO PLATFORMS LIMITED, Ahmedabad, Gujarat (IN)

(72) Inventors: Arun DEWNA, Jaipur, Rajasthan (IN); Amit Kumar SINGH, Kalyan East, Maharashtra (IN); Aarthi MUTHUPANDI, Kalyan West, Maharashtra (IN); Aditya GUPTA, Jaipur, Rajasthan (IN); Viswanadhuni Venkata PRUDHVI, Krishna, Andhra Pradesh (IN); Rakesh KUMAR, Navi Mumbai, Maharashtra (IN); Aayush BHATNAGAR, Navi Mumbai, Maharashtra (IN)

(73) Assignee: JIO PLATFORMS LIMITED, Ahmedabad, Gujarat (IN)

(21) Appl. No.: 18/993,200

(22) PCT Filed: Mar. 11, 2024
(86) PCT No.: PCT/IN2024/050244

§ 371 Date: Jan. 10, 2025

(30) Foreign Application Priority Data
Mar. 29, 2023 (IN) 202321023229

(51) Int. Cl. G06F 9/48; G06F 9/54

(52) U.S. Cl. CPC G06F 9/4887; G06F 9/542

(57) ABSTRACT

A method for event scheduling is disclosed. The method includes receiving, from a computing device (104), at least one event to be scheduled based on a predetermined time provided by the application, identifying, by a scheduling module (910), whether the at least one received event is a recurring event or a non-recurring event based on the predetermined time, and scheduling, by the scheduling module (910), the at least one event using a recurring event processor when the identified at least one event is a recurring event. In addition, the method includes scheduling, by the scheduling module (910), the at least one event using a non-recurring event processor when the at least one event is a non-recurring event, and notifying, by a notification engine (930), the at least one scheduled event to the application based on the predetermined time.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for scheduling in software applications. More particularly, the present disclosure relates to a system and a method for an adaptable scheduler that is versatile, fault tolerant, and provides scheduling of timer events at the granularity of seconds.

### BACKGROUND OF THE INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admission of the prior art.

Scheduling is commonly used in software applications where an event scheduling requirement may extend to any type of time granularity. Based on a business requirement, a main application may include a business logic implementation where a scheduler schedules events using multiple timers. However, processing multiple timers may lead to performance degradation and eventually malfunctioning of the application. Further, multiple timers scheduled in a particular process may cause aging or promotion of objects that may ultimately produce a major delay. Also, a requirement of scheduler replication may be mandatory upon deployment of applications a cluster of multiple instances to achieve a availability of the timer. Furthermore, inconsistencies may be encountered while setting a timer state of a particular event as the timer may lack the required synchronization.

Almost every application requires some kind of scheduling that may include tracking a particular condition to meet at a specified time, batch processing at a particular time, track the processing of a transaction, or performing a periodic job. Additionally, technical domains may include scheduling of millions of events where information may be lost during load durations. Hence such processes may trigger information state inconsistencies and revenue leaks.

Conventional schedulers provide minimum time granularity and require integration via hypertext transfer protocol (HTTP) leading to additional dependencies. Further, conventional schedulers may require a third-party infrastructure with an integration effort which may lack cost effectiveness and lead to an inefficient system.

There is, therefore, a need in the art to provide a system and a method that can mitigate the problems associated with the prior arts.

### SUMMARY

In an exemplary embodiment, the present invention discloses a method for providing a scalable timer for scheduling a plurality of events. The method comprising receiving, from a computing device, at least one event to be scheduled based on a predetermined time provided by an application. The method comprising identifying, by a scheduling module whether the at least one received event is a recurring event or a non-recurring event based on the predetermined time. The method comprising scheduling, by the scheduling module, the at least one event using a recurring event processor when the at least one determined event is a recurring event. The method comprising scheduling, by a scheduling module, the at least one event using a non-recurring event processor when the at least one event is a non-recurring event. The method comprising notifying, by a notification engine, the at least one scheduled event to the application based on the predetermined time.

In some embodiments, one notification is sent to the application when the at least one received event is a non-recurring event.

In some embodiments, the non-recurring events comprises relative non-recurring events and absolute non-recurring events.

In some embodiments, the relative non-recurring events are associated with a relative time with respect to a current time at which the notification is sent to the application.

In some embodiments, the absolute non-recurring events are associated with an exact time at which the notification is sent to the application.

In some embodiments, a plurality of notifications are sent to the application on a recurring basis when the at least one received event is a recurring event.

In some embodiments, the application is deployed as a cluster of a plurality of timer instances for receiving a plurality of scheduled events.

In some embodiments, the scheduling of the plurality of events is replicated across all the plurality of timer instances.

In some embodiments, the timer further comprises a replication module that provides event synchronization between the plurality of timer instances.

In some embodiments, the replication module replicates back the at least one scheduled event when at least one timer instance is unavailable to receive the at least one scheduled event.

In some embodiments, the timer works in a pair of active and hot-standby timer instances.

In some embodiments, the hot-standby timer instance sends the notification about the at least one scheduled event to the application when the active timer instance is unavailable.

In an exemplary embodiment, the present invention discloses an adaptable scheduler comprising a scalable timer for scheduling a plurality of events. The adaptable scheduler is configured to receive, from a computing device, at least one event to be scheduled based on a predetermined time provided by an application. The adaptable scheduler is configured to identify, by a scheduling module, whether the at least one received event is a recurring event or a non-recurring event based on the predetermined time. The adaptable scheduler is configured to schedule, by the scheduling module, the at least one event using a recurring event processor when the at least one determined event is a recurring event. The adaptable scheduler is configured to schedule, by a scheduling module, the at least one event using a non-recurring event processor when the at least one event is a non-recurring event. The adaptable scheduler is configured to notify, by a notification engine, the at least one scheduled event to the application based on the predetermined time.

In some embodiments, one notification is sent to the application when the at least one received event is a non-recurring event.

In some embodiments, the non-recurring events comprises relative non-recurring events and absolute non-recurring events.

In some embodiments, the relative non-recurring events are associated with a relative time with respect to a current time at which the notification is sent to the application.

In some embodiments, the absolute non-recurring events are associated with an exact time at which the notification is sent to the application.

In some embodiments, a plurality of notifications are sent to the application on a recurring basis when the at least one received event is a recurring event.

In some embodiments, the application is deployed as a cluster of a plurality of timer instances for receiving a plurality of scheduled events.

In some embodiments, the scheduling of the plurality of events is replicated across all the plurality of timer instances.

In some embodiments, the timer further comprises a replication module that provides event synchronization between the plurality of timer instances.

In some embodiments, the replication module replicates back the at least one scheduled event when at least one timer instance is unavailable to receive the at least one scheduled event.

In some embodiments, the timer works in a pair of active and hot-standby timer instances. In some embodiments, the hot-standby timer instance sends the notification about the at least one scheduled event to the application when the active timer instance is unavailable.

The foregoing general description of the illustrative embodiments and the following detailed description thereof are merely exemplary aspects of the teachings of this disclosure and are not restrictive.

### OBJECTS OF THE INVENTION

Some of the objects of the present disclosure, which at least one embodiment herein satisfies are listed herein below.

It is an object of the present disclosure to provide a system and a method for a scalable, fault tolerant, and resilient timer implementation.

It is an object of the present disclosure to provide a system and a method with a timer implementation that can schedule events to coarser granularities and work with any type of application while being deployed across various hardware implementations.

It is an object of the present disclosure to provide a system and a method with a common purpose scheduler which functions with multiple types of applications without any coding effort.

It is an object of the present disclosure to provide a system and a method with an available timer service that decouples rest of the application and generates near-real-time syncing of information between instances of timers.

It is an object of the present disclosure to provide a system and a method with the timer service that functions without a particular limit on run times.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture of a proposed system, in accordance with an embodiment of the present disclosure.

FIG. 2 illustrates an exemplary representation of a proposed system, in accordance with an embodiment of the present disclosure.

FIG. 3 illustrates an exemplary scheduling process of the system, in accordance with an embodiment of the present disclosure.

FIG. 4 illustrates an exemplary non-recurring event processor (NREP) by the system, in accordance with an embodiment of the present disclosure.

FIG. 5 illustrates an exemplary recurring event processor (REP) by the system, in accordance with an embodiment of the present disclosure.

FIG. 6 illustrates an exemplary notification engine of the REP, in accordance with an embodiment of the present disclosure.

FIG. 7 illustrates an exemplary event replication processor (ERP) of the system, in accordance with an embodiment of the present disclosure.

FIG. 8 illustrates an exemplary computer system in which or with which the proposed system may be implemented, in accordance with an embodiment of the present disclosure.

FIG. 9 illustrates an exemplary adaptive scheduler in accordance with an embodiment of the present disclosure.

The foregoing shall be more apparent from the following more detailed description of the disclosure.

### LIST OF REFERENCE NUMERALS

100—Network Architecture
102—A Plurality of Users
104—A Plurality of Computing Device
106—A Network
110—A System
112—A Timer
200—Representation of A Proposed System
202, 870—A Plurality of Processors
204—Memory
206—Interface(s)
208—Processing Engine
210—Database
212—Data Parameter Engine
214—Scheduling Engine
800—Computer System
810—An External Storage Device
820—A Bus
830—A Main Memory
840—A Read-only Memory
850—A Mass Storage Device
860—Communication Port(s)
900—An adaptive scheduler
910—Scheduling module
920—Replication module
930—Notification engine

### BRIEF DESCRIPTION OF THE INVENTION

In the following description, for explanation, various specific details are outlined in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive like the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is to describe particular embodiments only and is not intended to be limiting the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any combinations of one or more of the associated listed items.

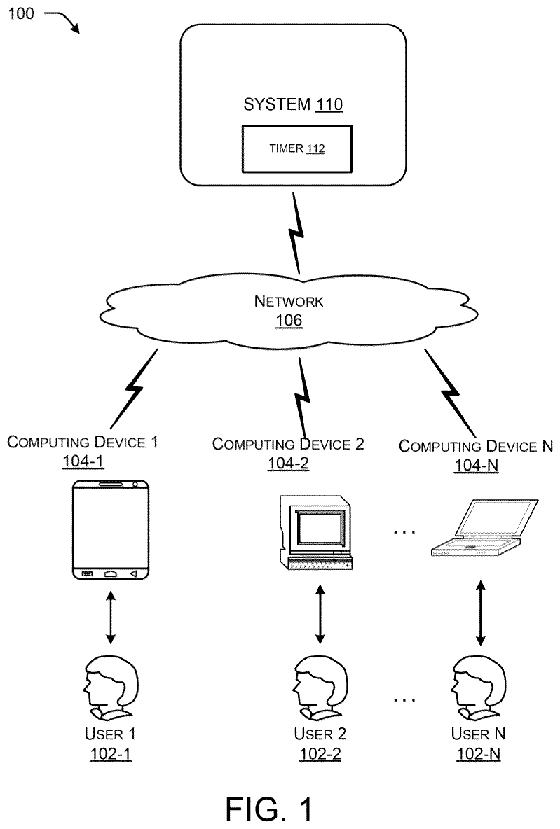

The various embodiments throughout the disclosure will be explained in more detail with reference to FIGS. 1-8.

FIG. 1 illustrates an exemplary network architecture (100) of a proposed system (110), in accordance with an embodiment of the present disclosure. As illustrated in FIG. 1, one or more computing devices (104-1, 104-2 . . . 104-N) are connected to the proposed system (110) through a network (106). A person of ordinary skill in the art will understand that the one or more computing devices (104-1, 104-2 . . . 104-N) are collectively referred as computing devices (104) and individually referred as a computing device (104). One or more users (102-1, 102-2 . . . 102-N) may operate the computing devices (104). A person of ordinary skill in the art will understand that the one or more users (102-1, 102-2 . . . 102-N) are collectively referred as users (102) and individually referred as user (102). The system (110) is interchangeably mentioned as a scheduler (110) throughout the disclosure.

In an embodiment, the computing device (104) may include, but not be limited to, a mobile, a laptop, etc. Further, the computing device (104) may include one or more in-built or externally coupled accessories including, but not limited to, a visual aid device such as a camera, audio aid, microphone, or keyboard. Further, the computing device (104) may include a mobile phone, smartphone, virtual reality (VR) devices, augmented reality (AR) devices, a laptop, a general-purpose computer, a desktop, a personal digital assistant, a tablet computer, and a mainframe computer. Additionally, input devices for receiving input from a user such as a touchpad, touch-enabled screen, electronic pen, and the like are used. In an embodiment, users/customers may submit their complaints through the computing devices (104) as shown in FIG. 1.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system/scheduler (110) (an adaptable scheduler) may receive one or more events via the computing devices (104). The system (110) is configured with a timer (112) that schedules the one or more events based on a predetermined time and identifies at least an event associated with the one or more events to be notified based on the predetermined time. The timer (112) is used to schedule the one or more events (which can be recurring or non-recurring) as per the predetermined time provided by a user application and notify the user application.

In an embodiment, the system (110) may include non-recurring events where a notification is sent only once. The non-recurring events are bifurcated into relative or absolute types. Absolute time may include an exact time at which a notification is expected, and relative time may include a time with respect to the current time (for e.g., 2 hours from now).

In an embodiment, the one event is scheduled using a recurring event processor when the one event is a recurring event.

In an embodiment, the system (110) may include recurring events that require notification to be sent on a recurring basis including but not limited to daily, hourly or every minute. The timer (112) is capable of scheduling the one or more events up to a second's granularity. For instance, the timer (112) may schedule an event that is scheduled to start at 10:40 PM time and run at an interval of every 6 minutes/hours/days. The start time of the event may also include the relative time.

In an embodiment, the one event is scheduled using a non-recurring event processor when the one event is a non-recurring event.

In an embodiment, if the user application wants to schedule certain events in a best effort approach at any given time and the number of notifications expected at that particular time is large, the user application may schedule those events efficiently in minute's granularity. For instance, the user application with millions of events is scheduled to run at 12:00 am every day.

In an embodiment, the user application may process certain events which have no specified time of execution but are equipped with a time-range in which the notifications are expected. The timer (112) may select a suitable timeslot from the given time-range in the event and provide the assigned timeslot back to the user application in response. Hence, such events are assigned timeslots as per minute's granularity. For instance, an event which may require notification to be sent between 10 pm to 12 pm is assigned a time slot from the 120 available timeslots (10 pm to 12pm means 2 hours which implies 120 minutes).

In an embodiment, the consumer application is notified about the one scheduled event.

In an embodiment, the timer (112) may include a scheduling module, a replication module, and a notification engine. The scheduling module is responsible for scheduling all the type of events associated with the one or more events with the predetermined time and may identify the events which are to be notified whenever the time comes.

In an embodiment, the replication module is utilized for event synchronization between the timer instances in a cluster and may facilitate a fault tolerance. In case where any of the timer instances are unavailable to receive the one or more events, the replication module may ensure that one or more events are replicated whenever. Also, if any one of the timer instances is unreachable from the user application, then as per the instruction from the user application, the reachable timer instance may inform the other instance about the event via a replication and clustering process.

In an embodiment, the system (110) may synchronize between one or more timer instances in a cluster and maintain the fault tolerance associated with the scheduling of the one or more events.

In an embodiment, the system (110) is configured with a notification engine that may send notifications corresponding to the one or more events based on the predetermined time. The notification engine is responsible to send notifications corresponding to the events at a given time either in form of pages or one notification for each event associated with the one or more events. Pages may constitute multiple notifications combined in a single notification to avoid network traffic. The decision of pagination is provided by the user application.

In an embodiment, the timer (112) may include pairs during active-hot standby instances. The active and hot-standby instances may include everything in common in terms of processing except for the notification engine. The active timer instance may include all three components working whereas the standby instance may exclude the notification engine. This implies that at any given time, only one instance may send notifications to the user application. The hot-standby instance may become active and may enable only the notification engine when the active instance is unavailable.

In an embodiment, the timer (112) may identify a type of event and store an event key and an event data in a data structure. Concurrently, the timer (112) may identify if the event has been marked for replication by the use application. If a replication is to be performed for that event, then the event is submitted to an event replication processor (ERP).

In an embodiment, the system (110) may convert the predetermined time to an absolute time by processing the one or more events.

In an embodiment, the system (110) may record one or more recurring events with at least an attribute that may include but not limited to a start-time, a recurring-frequency, an end-time, a last-execution-time, and a next-execution-time.

In an embodiment, the system (110) may utilize a custom replication framework to ensure the fault tolerance and a synchronization of one or more events within one or more timer instances.

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

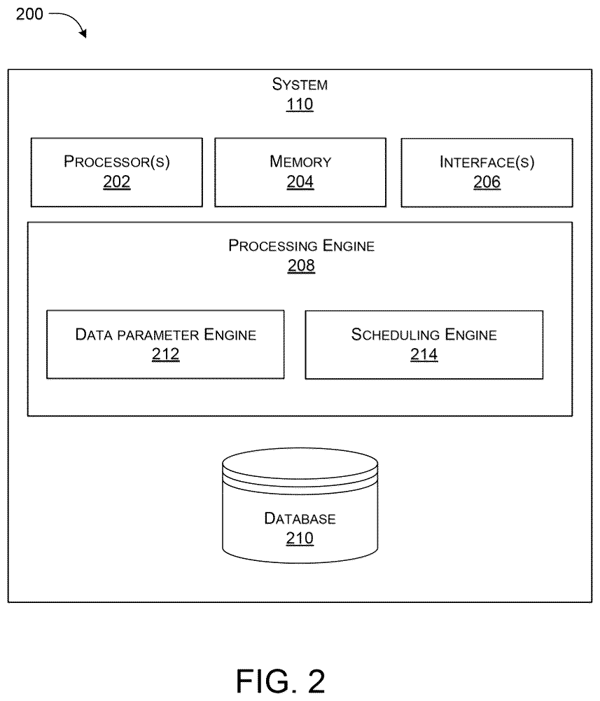

FIG. 2 illustrates an exemplary representation (200) of a proposed system (106), in accordance with an embodiment of the present disclosure.

Referring to FIG. 2, the system (110) may include one or more processor(s) (202). The one or more processor(s) (202) is implemented as one or more microprocessors, microcomputers, microcontrollers, digital signal processors, central processing units, logic circuitries, and/or any devices that process data based on operational instructions. Among other capabilities, the one or more processor(s) (202) is configured to fetch and execute computer-readable instructions stored in a memory (204) of the system (106). The memory (204) is configured to store one or more computer-readable instructions or routines in a non-transitory computer readable storage medium, which is fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output devices (I/O), storage devices, and the like. The interface(s) (206) may facilitate communication through the system (110). The interface(s) (206) may also provide a communication pathway for one or more components of the system (110). Examples of such components include, but are not limited to, processing engine(s) (208), a database (210), a data parameter engine (212), and a scheduling engine (214).

The processing engine(s) (208) is implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system may comprise the machine-readable storage medium storing the instructions and the processing resource to execute the instructions, or the machine-readable storage medium may be separate but accessible to the system and the processing resource. In other examples, the processing engine(s) (208) may be implemented by electronic circuitry.

In an embodiment, the processor (202) may receive one or more events form the computing devices (104) via the data parameter engine (212) and store the one or more events in the database (210). The processor (202) is configured with a timer (112) that may schedule the one or more events based on a predetermined time using the scheduling engine (214) and identify at least an event associated with the one or more events to be notified based on the predetermined time.

In an embodiment, the processor (202) may synchronize between one or more timer instances in a cluster and maintain a fault tolerance associated with the scheduling of the one or more events via the scheduling engine (214).

In an embodiment, the processor (202) is configured with a notification engine embedded in the scheduling engine (214) that may send notifications corresponding to the one or more events based on the predetermined time.

In an embodiment, the processor (202) may convert the predetermined time to an absolute time processing the one or more events via the scheduling engine (214).

In an embodiment, the processor (202) may record one or more recurring events via the data parameter engine (212) with at least an attribute that may include but not limited to a start-time, a recurring-frequency, an end-time, a last-execution-time, and a next-execution-time.

In an embodiment, the processor (202) may utilize a custom replication framework to ensure the fault tolerance and a synchronization of one or more events within one or more timer instances. The processor (202) may utilize the scheduling engine (214) to generate the synchronization of one or more events within one or more timer instances.

In an embodiment, the processor (202) may identify a type of event and store an event key and an event data in a data structure of the database (210). Concurrently, the processor (202) may identify if the event has been marked for replication by the user application. If a replication is to be performed for that event, then the event is submitted to an event replication processor (ERP) that is a part of the processor (202).

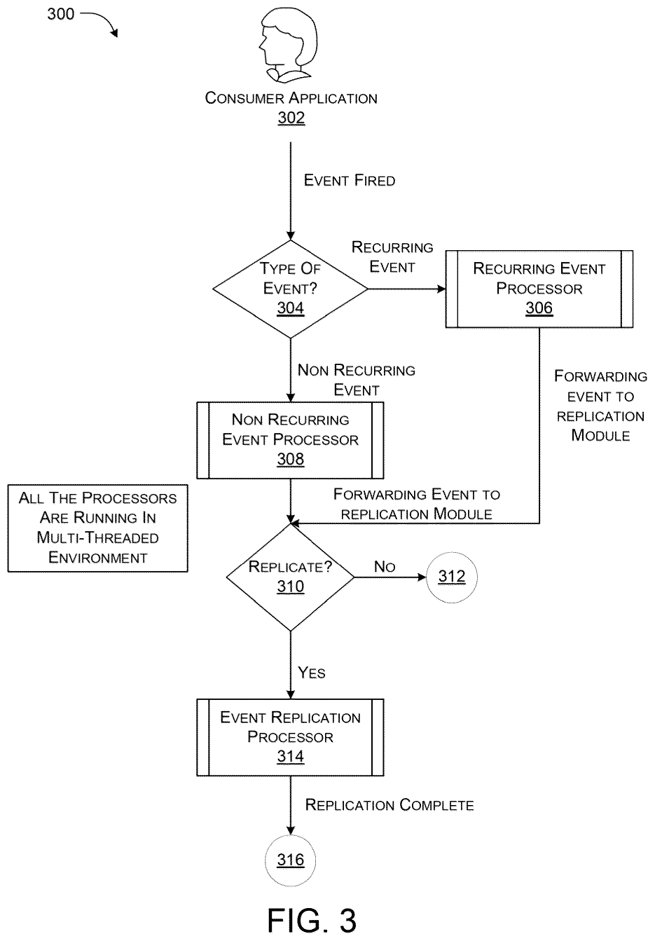

FIG. 3 illustrates an exemplary scheduling process (300) of the system (110), in accordance with an embodiment of the present disclosure.

As illustrated in FIG. 3, the following steps are utilized by the system (110).
At step 302: The user application/consumer application may send the one or more events to the system/scheduler (110).
At step 304: The system (110) may determine the type of event, if the event is a recurring event or a non-recurring event.
At step 306: Based on a positive determination for the recurring event, the event is sent to a recurring event processor (REP). Further, the REP may forward the event to a replication module.
At step 308: Based on a positive determination for the non-recurring event, the event is sent to a non-recurring event processor (NREP). Further, the NREP may forward the event to a replication module.
At step 310: The replication module may determine whether to replicate the event.
At step 312: Based on a negative determination obtained from step 310, the replication module may terminate the event.
At step 314: Based on a positive determination obtained from step 310, the replication module may send the event to the ERP.

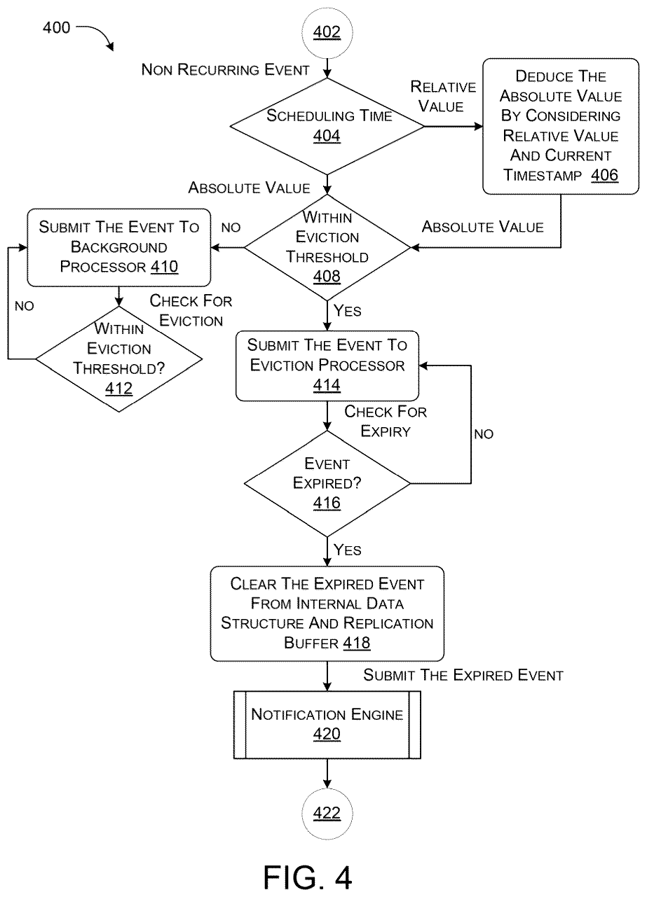

FIG. 4 illustrates an exemplary non-recurring event processor (NREP) (400) by the system (110), in accordance with an embodiment of the present disclosure.

In an embodiment, the NREP (400) upon receiving the non-recurring event, further checks if the scheduling time of the event is relative or absolute. If relative, the NREP (400) converts the scheduling time to an absolute time. The absolute scheduling time is compared with a current time and a variation (delta) may fall within an eviction threshold. Here, eviction threshold is a configured time relative to the current time within which if the event expiry falls, that event is submitted to the eviction processor. The eviction processor is a supervisory monitoring task that is running in seconds granularity and keeping track of the events whose expiry time is within the eviction threshold. However, if the delta is beyond the eviction threshold, the event is submitted to a background processor.

The background processor is a supervisory monitoring task that is running in minutes granularity and consistently keeping a check on the expiry of the submitted events if the events fall within the eviction threshold. Once the expiry time of a particular event falls within the eviction threshold, the event is submitted to the eviction processor. Further, the eviction processor may detect an event expiry and clear the expired event from an internal data structure and replicate a buffer. The eviction processor may submit the expired event to the notification engine.

As illustrated in FIG. 4, the following steps is utilized by the NREP (400).
At step 402: The NREP (400) may receive the non-recurring event.
At step 404: The NREP (400) may determine if the scheduling time is relative or absolute.
At step 406: Based on a positive determination obtained from step 404, the NREP (400) may deduce the absolute value by considering the relative and a time stamp. Further, the NREP (400) may further provide the absolute value for verification within an eviction threshold.
At step 408: Based on a positive determination obtained from step

404, the NREP (400) may further determine if the absolute value is within the eviction threshold.
At step 410: The NREP (400) may submit the event to the background processor.
At step 412: The NREP (400) may determine if the event is within an eviction threshold. Based on a negative determination, the NREP (400) continues with step 410.
At step 414: Based on a positive determination obtained from step 412, the NREP (400) may submit the event to the eviction processor.
At step 416: The NREP (400) may determine if the event has expired. Based on a negative determination obtained from step 414, the NREP (400) may continue with step 414.
At step 418: Based on a positive determination obtained from step 414, the NREP (400) may clear the expired event from the internal data structures and replicate the buffer.
At step 420: The NREP (400) may further submit the expired event to the notification engine.
At step 422: The NREP (400) may terminate the non-recurring event processing.

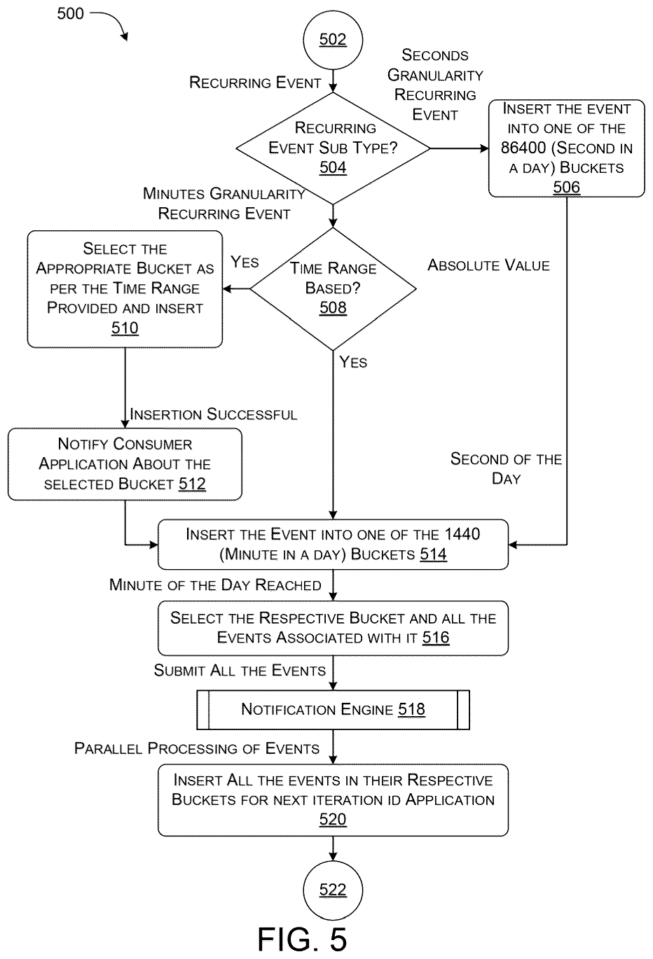

FIG. 5 illustrates an exemplary recurring event processor (REP) (500) by the system (110), in accordance with an embodiment of the present disclosure.

As illustrated in FIG. 5, the following steps is utilized by the REP (500).
At step 502: The REP (500) may receive the recurring event.
At step 504: The REP (500) may determine a sub type of the recurring event. The REP (500) may bifurcate the event into a minutes granularity recurring event and a seconds granularity recurring event.
At step 506: The REP (500) may insert the seconds granularity recurring event into one of the 86400 (seconds in a day) buckets.
At step 508: The REP (500) may utilize the minutes granularity recurring event and determine if the minutes granularity recurring event is time range based.
At step 510: Based on a positive determination obtained at step 508, the REP (500) may select the appropriate bucket as per the time range provided and follow a process of insertion.
At step 512: Upon successful insertion, the REP (500) may notify the consumer/user application about the selected bucket.
At step 514: Based on a negative determination obtained at step 508, the REP (500) may insert the event into one of the 1440 (minutes in a day) buckets.
At step 516: The REP (500) may utilize the minutes and the seconds of the day and select the respective bucket and all the events associated with it.
At step 518: The REP (500) may submit all the events to the notification engine.
At step 520: The REP (500) may include parallel processing of events and insert all the events in their respective buckets for the next iteration if applicable.
At step 520: the rep (500) may terminate the recurring event processing.

In an embodiment, the recurring event may include attributes such as the start-time, the recurring-frequency, the end-time, the last-execution-time, the next-execution-time. Here, start-time may include a time at which a first event notification may to be sent that is relative (say 1 day 2 hours and 30 minutes from now) or an absolute time (say Thu February 16 17:27:45 IST 2022).

In an embodiment, the recurring-frequency may include a period between successive notifications of the same event which is provided in terms of days, hours and minutes relative to the last notification of the event (say 2 D, 3 H, 50 M or 2 D 3 H50 M).

In an embodiment, a last-execution-time may include a time and date when a last successful notification of the event was sent (or the event was fired).

In an embodiment, a next-execution-time may include processing of the recurring-frequency and the last-execution-time to generate the next-execution-time. Based on the next-execution-time the next bucket is selected where the event is to be stored.

In an embodiment, an end-time may include a time at which the recurring-event is terminated i.e., no further notifications are sent. This may also include the relative or absolute time.

In an embodiment, when a recurring event is received by the REP (500), the REP (500) identifies the ‘Event-Type’ and determines if the event is categorized as the second's granularity event or the minute's granularity event.

In an embodiment, the REP (500) may process the second's granularity events. The events running at specific hours: minutes: seconds of a day i.e., even the seconds of the time also is taken into consideration. To handle these events, the timer may create (24×60×60)=86400 buckets (0-86399) i.e., a bucket for each second of the day. Based on the time of the day, a bucket number is assigned, and the event is stored in that bucket. Bucket number ‘0’ is assigned to 00:00:00 time of a day and is increased by one with each passing second of the day. For e.g., 14:25:30 time of the day is assigned a bucket number of 51930 (14×60×60+25*60+30). A supervisory task is running at an interval of a second in the background which may figure out the bucket number for each passing second of the day and determine if any event(s) is/are stored in that bucket. If any event(s) is found in the bucket, their next-execution-time is compared with the current time and further, if a match is found, the event(s) is sent to the notification engine. Moreover, if the timer finds that any event needs to be scheduled again for the next notification (based on the comparison between next-execution-time and end-time), the event's next-execution-time (and subsequently next bucket number) and the last-execution-time is updated. Further, the event is removed from the current bucket and stored in the calculated next bucket.

In an embodiment, the REP (500) may process the minute's granularity events whose seconds have been taken into consideration i.e., whose granularity is at minute level. To handle these events, the timer may create (24×60)= 1440 buckets (0-1439) i.e., a bucket for each minute of the day starting with 00:00:00 taken as 0th bucket. Further, the REP (500) may increase the bucket number by one for each passing minute of the day. For e.g., 14:25 (14th hour and 25th minute) time of the day is assigned a bucket number of 865 (14×60+25). A supervisory task is running at an interval of a minute in the background that may figure out the bucket number for each passing minute of the day and determine if any event(s) are stored in that bucket. If any event(s) is/are found in the bucket, then their next-execution-time is compared with the current time. If match is found, the event(s) is/are sent to the notification engine. Moreover, if the timer finds that any event needs to be scheduled again for next notification (based on the comparison between next-execution-time and end-time), the event's next-execution-time (and subsequently next bucket number) and the last-execution-time is updated. The event is removed from the current bucket and stored in the next calculated bucket.

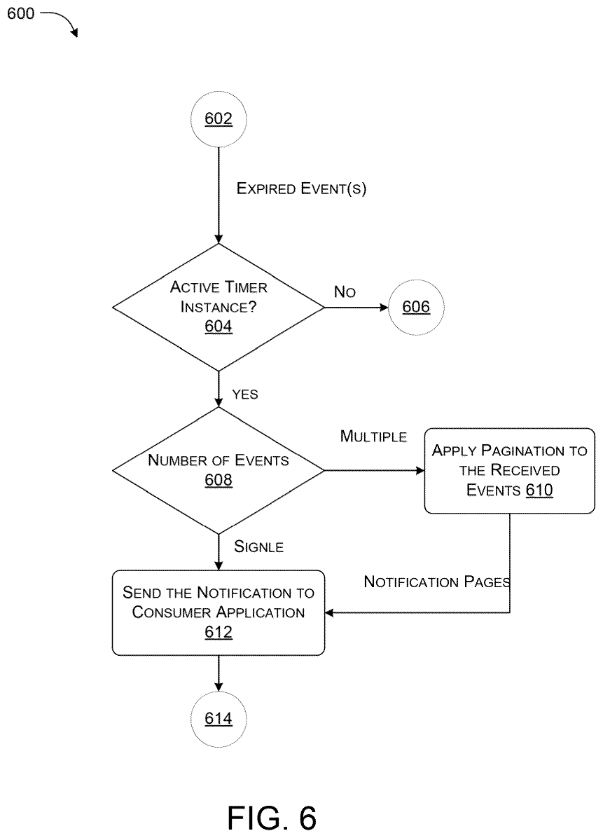

FIG. 6 illustrates an exemplary notification engine (600) of the REP, in accordance with an embodiment of the present disclosure.

As illustrated in FIG. 6, the following steps are utilized by the notification engine (600).
At step 602: The notification engine (600) may receive expired events.
At step 604: The notification engine (600) may determine if active timer instance have been generated for the expired events.
At step 606: Based on a negative determination observed from step 604, the notification engine (600) may terminate the processing.
At step 608: Based on a positive determination observed from step 604, the notification engine (600) may further determine the number of events.
At step 610: Based on detection of multiple events from step 608, the notification engine (600) may apply pagination to the received events and send the notification pages for further processing.
At step 612: Based on detection of a single event from step 608 and the received notification pages, the notification engine (600) may send the notification to the consumer/user application.
At step 614: The notification engine (600) may terminate the processing.

In an embodiment, the notification engine (600) is responsible to send notifications for the expired events. However, the notification engine (600) is enabled at only a one timer instance i.e., active timer instance. Upon receiving the expired event(s), only the active timer instance may take the responsibility for sending the notification(s). The notification engine (600) may take into account the number of events that have expired and determine if there are multiple notifications to be sent. Further, the consumer/user application may allow pagination where the notification engine (600) may create notification pages based on the page count provided by the consumer application. If pagination is disabled by the consumer application, then the notification engine (600) may send individual notifications for each expired event.

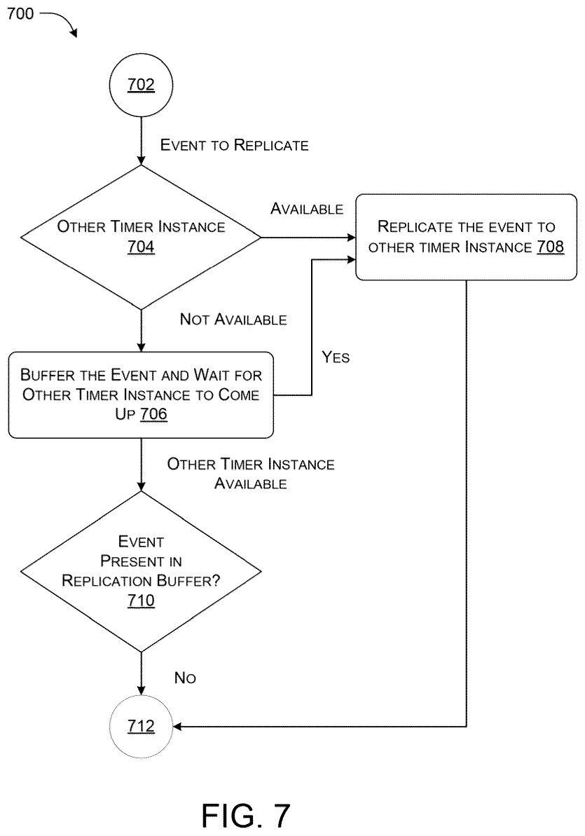

FIG. 7 illustrates an exemplary event replication processor (ERP) (700) of the system (110), in accordance with an embodiment of the present disclosure.

As illustrated in FIG. 7, the following steps are utilized by the ERP (700).
At step 702: The ERP (700) may receive the event to replicate.
At step 704: The ERP (700) may determine if other timer instances are configured with the events to be replicated.
At step 706: Based on a non-availability of the timer instance, the ERP (700) may buffer the event and wait for the other timer instance to come up.
At step 708: Based on an availability of the timer instance, the ERP (700) may replicate the event to other timer instance and terminate the processing.
At step 710: The ERP (700) may determine if an event is present in a replication buffer. Based on a positive determination, the ERP (700) may continue with step 708.
At step 712: Based on a negative determination observed from step 710, the ERP (700) may terminate the processing.

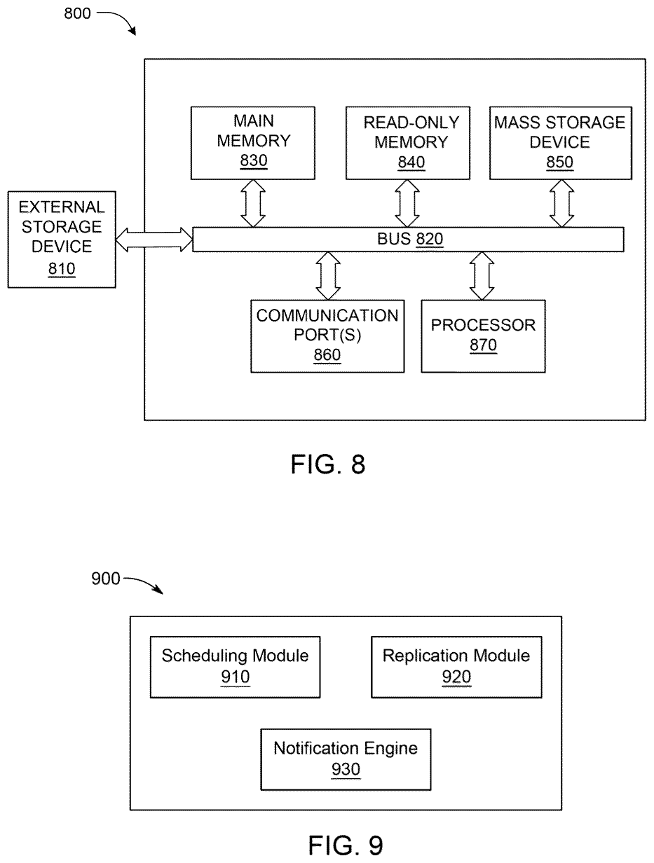

FIG. 8 illustrates an exemplary computer system (800) in which or with which the proposed system (110) is implemented, in accordance with an embodiment of the present disclosure.

As shown in FIG. 8, the computer system (800) may include an external storage device (810), a bus (820), a main memory (830), a read-only memory (840), a mass storage device (850), a communication port(s) (860), and a processor (870). A person skilled in the art will appreciate that the computer system (800) may include more than one processor and communication ports. The processor (870) may include various modules associated with embodiments of the present disclosure. The communication port(s) (860) may be any of an RS-232 port for use with a modem-based dialup connection, a 10/100 Ethernet port, a Gigabit or 10 Gigabit port using copper or fiber, a serial port, a parallel port, or other existing or future ports. The communication ports(s) (860) may be chosen depending on a network, such as a Local Area Network (LAN), Wide Area Network (WAN), or any network to which the computer system (800) connects.

In an embodiment, the main memory (830) may be Random Access Memory (RAM), or any other dynamic storage device commonly known in the art. The read-only memory (840) may be any static storage device(s) e.g., but not limited to, a Programmable Read Only Memory (PROM) chip for storing static information e.g., start-up or basic input/output system (BIOS) instructions for the processor (870). The mass storage device (850) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (820) may communicatively couple the processor(s) (870) with the other memory, storage, and communication blocks. The bus (820) may be, e.g., a Peripheral Component Interconnect PCI)/PCI Extended (PCI-X) bus, Small Computer System Interface (SCSI), USB, or the like, for connecting expansion cards, drives, and other subsystems as well as other buses, such a front side bus (FSB), which connects the processor (870) to the computer system (800).

In another embodiment, operator and administrative interfaces, e.g., a display, keyboard, and cursor control device may also be coupled to the bus (820) to support direct operator interaction with the computer system (800). Other operator and administrative interfaces can be provided through network connections connected through the communication port(s) (860). Components described above are meant only to exemplify various possibilities. In no way should the aforementioned exemplary computer system (800) limit the scope of the present disclosure.

FIG. 9 illustrates an exemplary adaptive scheduler (900) in accordance with an embodiment of the present disclosure. The adaptive scheduler (900) comprises a scheduling module (910), a replication module (920) and a notification engine (930). The scheduling module (910) is responsible for scheduling all the type of events associated with the one or more events with the predetermined time and may identify the events which are to be notified whenever the time comes.

In an embodiment, the replication module (920) is utilized for event synchronization between the timer instances in a cluster and may facilitate a fault tolerance. In case where any of the timer instances are unavailable to receive the one or more events, the replication module (920) may ensure that one or more events are replicated whenever. Also, if any one of the timer instances is unreachable from the user application, then as per the instruction from the user application, the reachable timer instance may inform the other instance about the event via a replication and clustering process.

In an embodiment, the adaptive scheduler (900) is configured with a notification engine (930) that may send notifications corresponding to the one or more events based on the predetermined time. The notification engine (930) is responsible to send notifications corresponding to the events at a given time either in form of pages or one notification for each event associated with the one or more events. Pages may constitute multiple notifications combined in a single notification to avoid network traffic. The decision of pagination is provided by the user application.

In an exemplary embodiment, the present invention discloses a method for providing a scalable timer for scheduling a plurality of events. The method comprising receiving, from a computing device, at least one event to be scheduled based on a predetermined time provided by an application. The method comprising identifying, by a scheduling module whether the at least one received event is a recurring event or a non-recurring event based on the predetermined time. The method comprising scheduling, by the scheduling module, the at least one event using a recurring event processor when the at least one determined event is a recurring event. The method comprising scheduling, by a scheduling module, the at least one event using a non-recurring event processor when the at least one event is a non-recurring event. The method comprising notifying, by a notification engine, the at least one scheduled event to the application based on the predetermined time.

The present disclosure is configured to provide a scalable, fault tolerant and resilient timer implementation which can schedule events from seconds and coarser granularity. The present disclosure is applicable to a wide range of applications and the disclosed timer can work for any type of application and can be deployed on commodity hardware. The disclosed timer can be implemented in a field of software development where scheduler or a timer is required. The present disclosure is configured to be employed in a communication system that requires a massive scheduler or a timer.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### ADVANTAGES OF THE INVENTION

The present disclosure provides a system and a method that provides scheduling of timer events at the granularity of seconds.

The present disclosure provides a system and a method that generates fault tolerance without any downtime.

The present disclosure provides a system and a method that caters to millions of timer events with the requirement of only two instances (active-hot standby) and a minimal system requirement.

The present disclosure provides a system and a method that performs without any restriction on incoming channels from the consumer application and hence is independent of a cluster size of the consumer application.

The present disclosure provides a system and a method that is capable of handling timer events from a large set of applications just by changing the configuration.

The present disclosure provides a system and a method that supports various types of timer events for scheduling.

The present disclosure provides a system and a method that deploys the timer service as a component of an application cluster.

1. A method for providing a scalable timer for scheduling a plurality of events, the method comprising:
receiving, from a computing device, at least one event to be scheduled based on a predetermined time provided by an application;
identifying, by a scheduling module, whether the at least one received event is a recurring event or a non-recurring event based on the predetermined time;
scheduling, by the scheduling module, the at least one event using a recurring event processor when the identified at least one event is the recurring event;
scheduling, by the scheduling module, the at least one event using a non-recurring event processor when the at least one event is the non-recurring event; and
notifying, by a notification engine, the at least one scheduled event to the application based on the predetermined time.

2. The method as claimed in claim 1, wherein one notification is sent to the application when the at least one received event is the non-recurring event.

3. (canceled)

4. The method as claimed in claim 2, wherein the non-recurring events comprise relative non-recurring events associated with a relative time with respect to a current time at which the notification is sent to the application.

5. The method as claimed in claim 2, wherein the non-recurring events comprise absolute non-recurring events associated with an exact time at which the notification is sent to the application.

6. The method as claimed in claim 1, wherein a plurality of notifications is sent to the application on a recurring basis when the at least one received event is the recurring event.

7. The method as claimed in claim 1, wherein the application is deployed as a cluster of a plurality of timer instances for receiving a plurality of scheduled events.

8. The method as claimed in claim 7, wherein the scheduling of the plurality of events is replicated across all the plurality of timer instances.

9. The method as claimed in claim 1, wherein the timer further comprises a replication module that provides event synchronization between a plurality of timer instances, and replicates back the at least one scheduled event when at least one timer instance is unavailable to receive the at least one scheduled event.

10. (canceled)

11. The method as claimed in claim 1, wherein the timer works in a pair of active timer instances and hot-standby timer instances, wherein a hot-standby timer instance sends the notification about the at least one scheduled event to the application when an active timer instance is unavailable.

12. (canceled)

13. An adaptable scheduler comprising a scalable timer for scheduling a plurality of events, the adaptable scheduler is configured to:
receive, from a computing device, at least one event to be scheduled based on a predetermined time provided by an application;
identify, by a scheduling module, whether the at least one received event is a recurring event or a non-recurring event based on the predetermined time;
schedule, by the scheduling module, the at least one event using a recurring event processor when the at least one determined event is the recurring event;
schedule, by the scheduling module, the at least one event using a non-recurring event processor when the at least one event is a the non-recurring event; and
notify, by a notification engine, the at least one scheduled event to the application based on the predetermined time.

14. The adaptable scheduler as claimed in claim 13, wherein one notification is sent to the application when the at least one received event is the non-recurring event.

15. (canceled)

16. The adaptable scheduler as claimed in claim 14, wherein the non-recurring events comprise relative non-recurring events associated with a relative time with respect to a current time at which the notification is sent to the application.

17. The adaptable scheduler as claimed in claim 14, wherein the non-recurring events comprise absolute non-recurring events associated with an exact time at which the notification is sent to the application.

18. The adaptable scheduler as claimed in claim 13, wherein a plurality of notifications is sent to the application on a recurring basis when the at least one received event is a the recurring event.

19. The adaptable scheduler as claimed in claim 13, wherein the application is deployed as a cluster of a plurality of timer instances for receiving a plurality of scheduled events.

20. The adaptable scheduler as claimed in claim 19, wherein the scheduling of the plurality of events is replicated across all the plurality of timer instances.

21. The adaptable scheduler as claimed in claim 13, wherein the adaptive scheduler further comprises a replication module that provides event synchronization between a plurality of timer instances, and replicates back the at least one scheduled event when at least one timer instance is unavailable to receive the at least one scheduled event.

22. (canceled)

23. The adaptable scheduler as claimed in claim 13, wherein the timer works in a pair of active timer instances and hot-standby timer instances, wherein a hot-standby timer instance sends the notification about the at least one scheduled event to the application when an active timer instance is unavailable.

24. (canceled)

25. A computer program product comprising a non-transitory computer-readable medium comprising instructions that, when executed by one or more processors, cause the one or more processors to perform a method for providing a scalable timer for scheduling a plurality of events, the method comprising:
receiving, from a computing device, at least one event to be scheduled based on a predetermined time provided by an application;
identifying, by a scheduling module, whether the at least one received event is a recurring event or a non-recurring event based on the predetermined time;
scheduling, by the scheduling module, the at least one event using a recurring event processor when the at least one determined event is the recurring event;
scheduling, by the scheduling module, the at least one event using a non-recurring event processor when the at least one event is the non-recurring event; and
notifying, by a notification engine, the at least one scheduled event to the application based on the predetermined time.
